(19) United States
(12) Patent Application Publication
(10) Pub. No.: US 2026/0074278 A1
(43) Pub. Date: Mar. 12, 2026

(54) SOLID ELECTROLYTE LAYER FOR LITHIUM SECONDARY BATTERY AND METHOD FOR PRODUCING SAME

(71) Applicants: Nissan Motor Co., Ltd., Kanagawa (JP); RENAULT S.A.S., Boulogne-Billancourt (FR)

(72) Inventor: Misaki Fujimoto, Kanagawa (JP)

(73) Assignees: Nissan Motor Co., Ltd., Kanagawa (JP); RENAULT S.A.S., Boulogne-Billancourt (FR)

(21) Appl. No.: 19/101,794

(22) PCT Filed: Aug. 7, 2023
(86) PCT No.: PCT/IB2023/000461

§ 371 Date: Feb. 6, 2025

(30) Foreign Application Priority Data
Aug. 9, 2022 (JP) 2022-126867

(51) Int. Cl. H01M 10/0562; H01M 10/052; H01M 10/0585; H01M 50/586

(52) U.S. Cl. CPC H01M 10/0562; H01M 10/052; H01M 10/0585; H01M 50/586; H01M 2300/0071; H01M 2300/0091

(57) ABSTRACT

A solid electrolyte layer for a lithium secondary battery that suppresses the generation of internal short-circuit caused by a dendrite composed of lithium metal is provided. The solid electrolyte layer includes a plurality of particles of a first solid electrolyte and a second solid electrolyte coating a surface of the plurality of particles and filling in a space among the plurality of particles. The second solid electrolyte is a sulfide solid electrolyte or an oxide solid electrolyte.

### TECHNICAL FIELD

The present invention relates to a solid electrolyte layer for a lithium secondary battery and a method for producing the solid electrolyte layer.

### BACKGROUND ART

In recent years, research and development on lithium secondary batteries such as an all-solid state secondary battery using an oxide-based or sulfide-based solid electrolyte as the electrolyte have been actively conducted. The solid electrolyte is a material mainly composed of an ion conductor capable of lithium ion conduction in a solid. For this reason, the all-solid state secondary battery has an advantage in that various problems caused by the combustible organic electrolyte solution do not occur in principle, unlike conventional liquid-type lithium ion secondary batteries.

Here, when the solid electrolyte layer for a lithium secondary battery is produced, a pressurization (press) treatment for pressurizing the solid electrolyte layer in a thickness direction thereof is commonly performed. Conventionally, for the purpose of achieving both high ion conductivity and high peel strength even though such a pressure-forming process is applied, it has been proposed to use a technique for forming a solid electrolyte layer of an all-solid state battery using two types of sulfide-based solid electrolyte particles different in Young's modulus and average particle diameter in combination (JP 2020-27701 A (US 2020/0052327 A)).

### SUMMARY OF INVENTION

### Technical Problem

However, as a result of examination by the present inventors, it was found that when the technique disclosed in the above literature is applied, an internal short-circuit caused by a dendrite composed of lithium metal generated in a negative electrode cannot be sufficiently suppressed.

Then, an object of the present invention is to provide a means capable of suppressing occurrence of an internal short-circuit caused by a dendrite composed of lithium metal in a lithium secondary battery having a solid electrolyte layer.

### Solution to Problem

The present inventors have conducted intensive studies with a view to solving the above problem. As a result, the present inventors found that the above problem is solved by filling a phase of the second solid electrolyte in the periphery of a plurality of particles formed of the first solid electrolyte to form a sea-island structure. Based on the finding, the present invention was accomplished.

To describe more specifically, an aspect of the present invention is directed to a solid electrolyte layer for a lithium secondary battery including a first phase composed of a plurality of particles of a first solid electrolyte, and a second phase composed of a second solid electrolyte coating the surface of the particles of the first solid electrolyte and filled in the space among the particles of the first solid electrolyte.

### BRIEF DESCRIPTION OF DRAWINGS

FIG. 1 is a cross-sectional view schematically showing an overall structure of a laminated (internally parallel connection type) all-solid-state lithium secondary battery (laminate type secondary battery) according to an embodiment of the present invention.

FIG. 2 is an enlarged cross-sectional view of the solid electrolyte layer shown in FIG. 1.

### DESCRIPTION OF EMBODIMENTS

An aspect of the present invention is directed to a solid electrolyte layer for a lithium secondary battery including a first phase composed of a plurality of particles of a first solid electrolyte, and a second phase composed of a second solid electrolyte coating the surface of the particles of the first solid electrolyte and filled in the space among the particles of the first solid electrolyte. According to the present invention, in a lithium secondary battery having a solid electrolyte layer, it is possible to effectively suppress occurrence of an internal short-circuit caused by a dendrite composed of lithium metal.

Hereinbelow, first, the overall structure of a lithium secondary battery having a solid electrolyte layer for a lithium secondary battery according to the present aspect will be described with reference to the accompanying drawings. Thereafter, when the components of the lithium secondary battery are described, the characteristic structure of the solid electrolyte layer according to the present aspect and the method for producing the same will be also described. Note that the technical scope of the present invention should be determined based on the description of the claims, and is not limited only to the following embodiments.

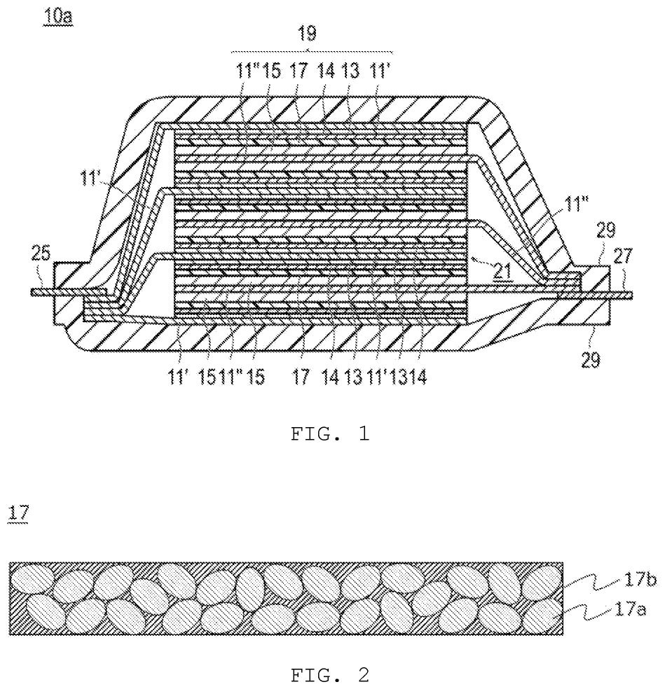

FIG. 1 is a cross-sectional view schematically showing an overall structure of a laminated (internal parallel connection type) all-solid-state lithium secondary battery (hereinafter, simply referred to also as a “laminate type secondary battery”), which is an embodiment of a solid electrolyte layer according to the present embodiment. FIG. 1 shows a cross section of a laminate type secondary battery during charging. The laminate type secondary battery 10a shown in FIG. 1 has a structure in which a substantially rectangular power generating element 21, in which a charge-discharge reaction actually proceeds, is sealed within a laminate film 29 serving as a battery outer casing body. Here, the power generating element 21 has a structure formed by laminating a negative electrode, a solid electrolyte layer 17, and a positive electrode. The negative electrode has a structure in which a negative electrode current collector 11′, a negative electrode active material layer 13 composed of lithium metal deposited on the surface of the negative electrode current collector 11′, and a negative electrode intermediate layer 14 containing silver nanoparticles and carbon black and disposed between the negative electrode active material layer 13 and the solid electrolyte layer 17, are laminated. The positive electrode has a structure in which a positive electrode active material layer 15 is disposed on a surface of a positive electrode current collector 11″. The negative electrode, the solid electrolyte layer, and the positive electrode are laminated in this order such that the negative electrode intermediate layer 14 and the positive electrode active material layer 15 adjacent thereto face each other with the solid electrolyte layer 17 interposed between them. In this way, the adjacent negative electrode, solid electrolyte layer, and positive electrode constitute a single battery layer 19. Accordingly, it can be said that the laminate type secondary battery 10a shown in FIG. 1 has a structure formed by laminating a plurality of single battery layers 19 and electrically connecting them in parallel. To the negative electrode current collector 11′ and the positive electrode current collector 11″, a negative electrode current collecting plate 25 and a positive electrode current collecting plate 27 are attached respectively, which are electrically connected to the respective electrodes (the negative electrode and the positive electrode) and led out of the laminate film 29 such that they are sandwiched between end parts of the laminate film 29. A confining pressure is applied to the laminate type secondary battery 10a in the lamination direction of the power generating elements 21 by the pressurizing member (not illustrated). Therefore, the volume of the power generating element 21 is kept constant.

Hereinafter, main structural members of the lithium secondary battery to which the solid electrolyte layer according to the present embodiment is applied will be described.

### [Current Collector]

The current collector (negative electrode current collector, positive electrode current collector) has a function to mediate transfer of electrons from the electrode active material layer. A material constituting the current collector is not particularly limited. Examples of a constituent material for the current collector that can be employed include a metal such as aluminum, nickel, iron, stainless steel, titanium, or copper, or a resin having conductivity. The thickness of the current collector is also not particularly limited, and is, for example, 10 to 100 μm.

### [Negative Electrode Active Material Layer]

The negative electrode active material layer 13 contains a negative electrode active material, and may contain a solid electrolyte, a binder, and a conductive aid as necessary. Examples of the type of negative electrode active material include, but are not particularly limited, a carbon material, a metal oxide, and a metal active material. As the negative electrode active material, an active material containing lithium may be used. Such a negative electrode active material is not particularly limited as long as it is an active material containing lithium. Examples thereof include metal lithium and lithium-containing alloys. Examples of the lithium-containing alloys include an alloy of Li and at least one of In, Al, Si, Sn, Mg, Au, Ag, and Zn. The negative electrode active material preferably contains metal lithium or a lithium-containing alloy, a silicon-based negative electrode active material, or a tin-based negative electrode active material, and particularly preferably contains metal lithium or a lithium-containing alloy. When metal lithium or a lithium-containing alloy is used as the negative electrode active material, the lithium secondary battery is preferably a so-called lithium deposition type in which lithium metal as a negative electrode active material is to be deposited on the negative electrode current collector in a charging process. In this case, since the layer composed of lithium metal to be deposited on the negative electrode current collector in the charging process becomes the negative electrode active material layer, the thickness of the negative electrode active material layer increases as the charging process proceeds, conversely, the thickness of the negative electrode active material layer decreases as the discharging process proceeds. The negative electrode active material layer may not be present at the time of full discharge, but in some cases, a negative electrode active material layer composed of a certain amount of lithium metal may be disposed at the time of full discharge. The thickness of the negative electrode active material layer (lithium metal layer) at the time of full charge is not particularly limited, but is usually 0.1 to 1000 μm.

### [Negative Electrode Intermediate Layer]

The lithium secondary battery preferably has a negative electrode intermediate layer 14 shown in FIG. 1. The negative electrode intermediate layer is a layer interposed between the negative electrode active material layer and the solid electrolyte layer, and contains a lithium reactive material. Examples of the lithium reactive material include a material capable of occluding and releasing lithium ions during charging and a metal capable of alloying with lithium during charging.

The material capable of occluding and releasing lithium ions is not particularly limited, but is preferably a carbon material. Specific examples of the carbon material include carbon black (e.g., acetylene black, Ketjen black (registered trademark), furnace black, channel black, thermal lamp black), carbon nanotube (CNT), graphite, hard carbon, and the like. Of them, carbon black is preferable, and at least one selected from the group consisting of acetylene black, Ketjen black (registered trademark), furnace black, channel black, and thermal lamp black is more preferable.

Examples of the metal capable of alloying with lithium include In, Al, Si, Sn, Mg, Au, Ag, Zn, and the like. Of them, In, Si, Sn, and Ag are preferable, and Ag is more preferable.

The lithium reactive materials may be used singly or in combination of two or more types thereof. As an embodiment of using two or more types in combination, combination use of a material capable of occluding and releasing lithium ions and a metal capable of alloying with lithium is also a preferable embodiment. In this case, sufficient strength and degree of lithium-ion conductivity of the negative electrode intermediate layer can be ensured. More specifically, a case where nanoparticles composed of In, Si, Sn, and Ag and carbon black are used in combination is preferable, and a case where nanoparticles composed of Ag and carbon black are used in combination is more preferable. In the case where the material capable of occluding and releasing lithium ions and a metal capable of alloying with lithium are used in combination, the blend ratio (mass ratio) of them is not particularly limited, but the ratio of the material capable of occluding and releasing lithium ions: a metal capable of alloying with lithium is preferably 10:1 to 1:1, and more preferably 5:1 to 2:1.

The content (when two or more types of materials are used in combination, the total content of the materials is referred to. The same applies hereinafter) of the lithium reactive material in the negative electrode intermediate layer is not particularly limited, but preferably falls within a range of 50 to 100 mass %, more preferably 70 to 100 mass %, still more preferably 85 to 99 mass %, and particularly preferably 90 to 100 mass %.

The negative electrode intermediate layer may be composed of a lithium-reactive material alone as long as a self-supported film can be composed of a lithium-reactive material alone, but may contain a binder as necessary. The type of binder is not particularly limited, and those known in the technical field to which the invention pertains can be appropriately employed. Examples thereof include polyvinylidene fluoride (PVDF) (including compounds in which a hydrogen atom is substituted with another halogen element), polytetrafluoroethylene (PTFE), styrene-butadiene rubber (SBR), and carboxymethyl cellulose.

The content of the binder in the negative electrode intermediate layer is not particularly limited, but is preferably within a range of 1 to 15 mass %, and more preferably within a range of 5 to 10 mass %. If the content of the binder is 1 mass % or more, a negative electrode intermediate layer having sufficient strength can be formed. If the content of the binder is 15 mass % or less, a negative electrode intermediate layer having a sufficient lithium-ion conductivity can be formed.

The thickness of the negative electrode intermediate layer is not particularly limited, but is preferably 1 to 50 μm, more preferably 5 to 40 μm, and still more preferably 10 to 30 μm. If the thickness of the negative electrode intermediate layer is 1 μm or more, the function of the negative electrode intermediate layer can be sufficiently exhibited. If the thickness of the negative electrode intermediate layer is 50 μm or less, a decrease in energy density can be suppressed.

### [Solid Electrolyte Layer]

The solid electrolyte layer is interposed between the negative electrode and the positive electrode, contains a solid electrolyte, and may contain a binder as necessary. The solid electrolyte layer according to the present aspect has a first phase composed of a plurality of particles of a first solid electrolyte, and a second phase composed of a second solid electrolyte coating the surface of the particles of the first solid electrolyte and filled in the space among the particles of the first solid electrolyte. Here, the first solid electrolyte and the second solid electrolyte are materials different from each other. As an embodiment of the solid electrolyte layer according to the present aspect, an enlarged cross-sectional view of the solid electrolyte layer 17 shown in FIG. 1 is shown in FIG. 2.

As shown in FIG. 2, the solid electrolyte layer 17 has a first phase 17a composed of a plurality of particles of Li₇P₃S₁₁ which is a sulfide-based solid electrolyte, and a second phase 17b composed of Li₆PS₅Cl which is another sulfide-based solid electrolyte. The second phase 17b composed of Li₆PS₅Cl coats the surface of the plurality of particles of Li₇P₃S₁₁ constituting the first phase 17a, and is filled in the space among the plurality of particles of Li₇P₃S₁₁. As described above, the first phase 17a composed of a plurality of particles of Li₇P₃S₁₁ and the second phase 17b composed of Li₆PS₅Cl integrally constitute the solid electrolyte layer 17 having a sea-island structure.

The first solid electrolyte constituting the first phase and the second solid electrolyte constituting the second phase are not particularly limited, and solid electrolytes conventionally known can be appropriately used. Examples of the solid electrolyte include sulfide-based solid electrolytes and oxide-based solid electrolytes.

Examples of the sulfide solid electrolyte include LiI—Li₂S—SiS₂, LiI—Li₂S—P₂O₅, LiI—Li₃PO₄—P₂S₅, Li₂S—P₂S₅, LiI—Li₃PS₄, LiI—LiBr—Li₃PS₄, Li₃PS₄, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers, and Z is any one of Ge, Zn, and Ga), Li₂S—GeS₂, Li₂S—SiS₂—Li₃PO₄, Li₂S—SiS₂-LiₓMO_{y} (wherein x and y are positive numbers, and M is any one of P, Si, Ge, B, Al, Ga, and In), and the like. Note that, the description of “Li₂S—P₂S₅” means a sulfide solid electrolyte using a raw material composition containing Li₂S and P₂S₅, and the same applies to other descriptions.

The sulfide solid electrolyte may have, for example, a Li₃PS₄ skeleton, a Li₄P₂S₇ skeleton, or a Li₄P₂S₆ skeleton. Examples of the sulfide solid electrolyte having a Li₃PS₄ skeleton include LiI—Li₃PS₄, LiI—LiBr—Li₃PS₄, and Li₃PS₄. Examples of the sulfide solid electrolyte having a Li₄P₂S₇ skeleton include a Li—P—S-based solid electrolyte called LPS (for example, Li₇P₃S₁₁). As the sulfide solid electrolyte, for example, LGPS or the like, represented by Li₍₄₋ₓ₎Ge₍₁₋ₓ₎PₓS₄ (x satisfies 0<x<1) may be used. Of them, a sulfide solid electrolyte containing P element is preferable. Furthermore, the sulfide solid electrolyte may contain halogen (F, Cl, Br, I), and an example thereof includes Li₆PS₅X (wherein X is Cl, Br or I, preferably Cl).

In addition, the sulfide solid electrolyte may be sulfide glass, crystallized sulfide glass, or a crystalline material obtained by a solid phase method. Note that, the sulfide glass can be obtained, for example, by mechanical milling (e.g., ball milling) of the raw material composition. The crystallized sulfide glass can be obtained, for example, by heat-treating the sulfide glass at the crystallization temperature or more.

Examples of the oxide solid electrolyte include a compound having a NASICON-type structure or the like. Examples of the compound having a NASICON-type structure include a compound (LAGP) or the like represented by the general formula Li₁₊ₓAlₓGe₂₋ₓ(PO₄)₃ (0≤x≤2) and a compound (LATP) represented by the general formula Li₁₊ₓAlₓTi₂₋ₓ(PO₄)₃ (0≤x≤2). Other examples of the oxide solid electrolyte include LiLaTiO (for example, Li_{0.34}La_{0.51}TiO₃), LiPON (for example, Li_{2.9}PO_{3.3}N_{0.46}), LiLaZrO (for example, Li₇La₃Zr₂O₁₂), and the like.

In a preferred embodiment, from the viewpoint of exhibiting a more excellent lithium-ion conductivity, both the first solid electrolyte and the second solid electrolyte are preferably sulfide-based solid electrolytes. In consideration of production by a production method described later, there is an advantage that a solid electrolyte layer can be produced by a simple method if a sulfide-based solid electrolyte is used as the second solid electrolyte. In a particularly preferred embodiment, the first solid electrolyte is LPS (for example, Li₇P₃S₁₁) or LGPS, and the second solid electrolyte is Li₆P₅X (for example, Li₆PS₅Cl).

The filling rate of the solid electrolyte layer according to the present aspect is preferably 85% or more, and more preferably 90% or more. The filling rate is further preferably, e.g., 91% or more, 92% or more, 93% or more, 94% or more, 95% or more, and 96% or more. The larger the filling rate of the solid electrolyte layer, the denser the layer becomes. Thus, the internal short-circuit caused by a dendrite generated from lithium metal can be more effectively suppressed. Note that the value of the filling rate of the solid electrolyte layer is the volume ratio of the constituent material of the solid electrolyte layer to the apparent volume of the solid electrolyte layer, that is a value obtained by subtracting the void ratio [%] from 100%. Incidentally, the values of the filling rate and the void ratio can be calculated by the method described in the section of Examples (described later).

For the same reason as described above, the surface of the particles of the first solid electrolyte is preferably coated with the second solid electrolyte as much as possible. Here, the value of the coverage, which is defined as the ratio of the surface area of the particles of the first solid electrolyte covered with the second solid electrolyte, is preferably 80% or more, more preferably 90% or more, still more preferably 93% or more, still more preferably 94% or more, particularly preferably 95% or more, and most preferably 98% or more. Note that the value of the coverage can be calculated by the method described in the section of Examples (described later). In addition, from the viewpoint of easily achieving the values of coverage mentioned above, it is preferable that the first phase and the second phase form a sea-island structure constituted of the first phase as a dispersed phase (island) and the second phase as a continuous phase (sea).

Furthermore, from the viewpoint of increasing the density of the entire solid electrolyte layer to suppress the occurrence of internal short-circuit caused by generation of a dendrite, the density of the first solid electrolyte is preferably higher than the density of the second solid electrolyte. Note that, which has larger density or not between the first solid electrolyte and the second solid electrolyte can be determined based on the difference in contrast when the observation image of the cross-section observed by the scanning electron microscope (SEM) described in the section of Examples (described later) is analyzed by ternarization. That is, it is possible to determine that the brighter the contrast of the image is, the larger density the solid electrolyte has. The specific density values of the first solid electrolyte and the second solid electrolyte are not particularly limited.

A case where the content ratio of the first phase containing the first solid electrolyte of the first phase and the second phase constituting the solid electrolyte layer is large to some extent is preferable since the conduction path of lithium ions in the solid electrolyte layer becomes less likely to be divided. Specifically, the volume content of the first phase (first solid electrolyte) in the solid electrolyte layer is preferably 50 vol % or more, more preferably 60 vol % or more, still more preferably 70 vol % or more, still more preferably 72 vol % or more, particularly preferably 73 vol % or more, and most preferably 78 vol % or more. In contrast, the volume content of the second phase (second solid electrolyte) in the solid electrolyte layer is preferably 50 vol % or less, more preferably 40 volt or less, still more preferably 30 vol % or less, still more preferably 28 vol % or less, particularly preferably 27 vol % or less, and most preferably 22 volt or less. The values of these volume contents can be calculated by the method described in the section of Examples (described later).

The degree of lithium-ion conductivity of the solid electrolyte constituting the solid electrolyte layer at normal temperature (25° C.) is not particularly limited, but the degree of lithium-ion conductivity of the first solid electrolyte is preferably higher than the degree of lithium-ion conductivity of the second solid electrolyte. In particular, when the volume content of the first phase (first solid electrolyte) in the solid electrolyte layer falls within the range of 50 volt or more as described above, for example, it is preferable that the degree of lithium-ion conductivity satisfies the above relationship because the degree of lithium-ion conductivity of the entire solid electrolyte layer is also improved. In general, since the degree of lithium-ion conductivity of the solid electrolyte greatly decreases when dissolved in a solvent, it is preferable that the degree of lithium-ion conductivity satisfies the above relationship also when the solid electrolyte layer is produced by a production method according to another aspect of the present invention (described later). Specifically, the degree of lithium-ion conductivity (25° C.) of the first solid electrolyte is preferably 0.01 mS/cm or more, more preferably 0.1 mS/cm or more, still more preferably 1.0 mS/cm or more, and particularly preferably 1.6 mS/cm or more. The value of the degree of lithium-ion conductivity of the solid electrolyte can be measured by an AC impedance method.

As described above, the solid electrolyte layer may further contain an additive such as a binder, but the content of the solid electrolyte in the solid electrolyte layer is preferably 50 to 100 mass %, more preferably 90 to 100 mass %, particularly preferably 95 to 100 mass %, and most preferably 98 to 100 mass %.

The thickness of the solid electrolyte layer varies depending on the structure of the desired lithium secondary battery, but is usually 0.1 to 1000 μm, preferably 100 to 400 μm, and more preferably 150 to 230 μm.

According to another aspect of the present invention, a method for producing the solid electrolyte layer mentioned above is also provided. That is, another aspect of the present invention relates to a method for producing a solid electrolyte layer for a lithium secondary battery. Here, the production method includes an impregnation step of impregnating the void space of a solid electrolyte layer precursor formed by accumulating particles of a first solid electrolyte like a layer with a solution having a second solid electrolyte dissolved in a solvent, and a solvent removal step of removing the solvent from the solid electrolyte layer precursor impregnated with the solution. It is also characterized in that the solubility of the second solid electrolyte to the solvent is higher than that of the first solid electrolyte to the solvent. According to such a production method, the solid electrolyte layer according to an aspect of the present invention can be produced by a simple method. Hereinafter, this production method will be described in order of steps.

### (Impregnation Step)

In the impregnation step, the void space of the solid electrolyte layer precursor formed by accumulating particles of the first solid electrolyte like layers is impregnated with a solution having the second solid electrolyte dissolved in a solvent. Here, specific types, preferable relationships, or the like of the first solid electrolyte and the second solid electrolyte are the same as described above.

A method for obtaining a solid electrolyte layer precursor formed by accumulating particles of the first solid electrolyte like a layer is not particularly limited, but as an example, first, the first solid electrolyte and a binder as necessary are added to an appropriate solvent to prepare a slurry containing the first solid electrolyte. Subsequently, the slurry is applied to the surface of an appropriate support, and the solvent is dried to obtain a solid electrolyte layer precursor. At this time, for example, if e.g., the type and particle diameter of the first solid electrolyte, and the addition amount of the binder are controlled, the filling rate of the obtained solid electrolyte layer, and the volume content of the first solid electrolyte can be controlled.

On the other hand, in the impregnation step, a solution having the second solid electrolyte dissolved in a solvent is prepared. The specific type of solvent is not particularly limited as long as the solvent has higher solubility to the second solid electrolyte at the operation temperature (for example, 25° C.) than to the first solid electrolyte. The solvent is preferably a solvent exhibiting high solubility to the second solid electrolyte. Specific examples of the solvent include lower alcohols having 1 to 4 carbon atoms such as ethanol, and aprotic polar solvents such as tetrahydrofuran, dimethyl sulfoxide, acetone, dichloromethane, diethyl ether, ethyl acetate, and the like. The concentration of the solution having the second solid electrolyte dissolved in the solvent is also not particularly limited, but from the viewpoint of more effectively introducing the second solid electrolyte into the void space of the solid electrolyte layer precursor, the higher the concentration of the solution, the more preferable. As an example, the concentration of the solution is preferably 5 g/L or more, more preferably 10 g/L or more, still more preferably 15 g/L or more, and particularly preferably 20 g/L or more.

In the impregnation step, a specific method for impregnating the void space of the solid electrolyte layer precursor with the solution is not particularly limited, and the solid electrolyte layer precursor may be immersed in the solution for a certain period of time, or an appropriate amount of the solution may be added dropwise to the solid electrolyte layer precursor. The present inventors, for the first time, found that the solubility greatly varies depending on the types of solid electrolyte and solvent used in combination. When the solubility of the first solid electrolyte is almost the equal to or higher than the solubility of the second solid electrolyte, the first solid electrolyte is also dissolved in the solvent when impregnated with the solution of the second solid electrolyte in the impregnation step, with the result that a desired solid electrolyte layer cannot be prepared. In contrast, if a solid electrolyte having higher solubility to a solvent is employed as the second solid electrolyte, a solid electrolyte layer can be produced by the above method. That is, the method for producing a solid electrolyte layer according to the present aspect is accomplished based on the finding of the present inventors on the difference in solubility.

After the impregnation step, a solvent removal step of removing the solvent from the solid electrolyte layer precursor impregnated with the solution is performed. Here, before the solvent removal step, a permeation step may be further performed, in which the solution is permeated into the void space of the solid electrolyte layer precursor by placing the solid electrolyte layer precursor under reduced pressure conditions. There are no particular limitations on the specific depressurization conditions and depressurization methods for carrying out the permeation step, and, for example, the solid electrolyte layer precursor after the impregnation step may be placed in a vacuum drying furnace. The specific drying conditions and drying method for carrying out the solvent removal step are also not particularly limited. If the operation of placing the solid electrolyte layer precursor in the vacuum drying furnace is used, the permeation step and the solvent removal step can be simultaneously carried out. As an example of the conditions when the permeation step and the solvent removal step are simultaneously performed using a vacuum drying furnace, the condition of 0.5 to 2 hours at room temperature (15 to 25° C.) is mentioned.

From the viewpoint of reliably introducing the second solid electrolyte into the void space of the solid electrolyte layer precursor, it is preferable to repeat a combination of the impregnation step, the permeation step, and the solvent removal step described above, twice or more. The number of repetitions is not particularly limited, but is preferably 2 to 5, more preferably 2 to 4, and still more preferably 2 to 3. When these steps are repeated, it is preferable to gradually increase the concentration of the solution of the second solid electrolyte used in the impregnation step.

In addition, after the solvent removal step mentioned above (after the last solvent removal step is performed if the step mentioned above is repeated) is performed, it is preferable that a heating step of heating the solid electrolyte layer precursor is further performed. By the method, it is possible to eliminate grain boundaries among the particles of the first solid electrolyte and the grain boundary between the first solid electrolyte and the second solid electrolyte, and offer an advantage that the degree of lithium-ion conductivity can be further improved. The heating condition at this time is not particularly limited, and, is for example, a heating condition of 80 to 200° C. (preferably 100 to 180° C.) for 1 to 10 hours (preferably 3 to 7 hours). This heating step is also preferably performed under a reduced pressure condition using, e.g., a vacuum drying furnace.

Further, after the solvent removal step mentioned above is performed (after the last solvent removal step is performed when the step mentioned above is repeated), it is preferable to further perform a press step of subjecting the solid electrolyte layer precursor to a pressurization treatment. Accordingly, the filling rate of the solid electrolyte layer can be improved, and a denser solid electrolyte layer can be prepared. As a result, it is possible to more reliably suppress occurrence of an internal short-circuit caused by a dendrite of lithium metal. The pressing pressure of pressurization treatment in the press step is not particularly limited, but is preferably 50 MPa or more, more preferably 100 MPa or more, still more preferably 150 MPa or more, and particularly preferably 200 MPa or more from the viewpoint of obtaining a dense solid electrolyte layer. The upper limit value of the pressing pressure is also not particularly limited, but is usually 500 MPa or less. When the heating step is performed after the solvent removal step, the press step may be performed before or after the heating step, but the press step is preferably performed after the heating step.

### [Positive Electrode Active Material Layer]

The positive electrode active material layer essentially contains a positive electrode active material, and may contain a solid electrolyte, a binder, and a conductive aid as necessary.

The type of positive electrode active material to be contained in the positive electrode active material layer is not particularly limited, and examples thereof include layered rock salt type active materials such as, LiCoO₂, LiMnO₂, LiNiO₂, and LiVO₂, Li(Ni—Mn—Co)O₂, spinel type active materials such as LiMn₂O₄, and LiNi_{0.5}Mn_{1.5}O₄, olivine type active materials such as LifePO₄, and LiMnPO₄, and Si-containing active materials such as Li₂FeSiO₄, Li₂MnSiO₄, and the like. Examples of the oxide active material other than those described above include Li₄Ti₅O₁₂. Of them, Li(Ni—Mn—Co)O₂ and a material obtained by substituting part of these transition metals with other elements (hereinafter, also simply referred to as “NMC composite oxide”) are preferably used as the positive electrode active material.

It is also one of preferred embodiments that a sulfur-based positive electrode active material is used. Examples of the sulfur-based positive electrode active material include particles or thin films of an organic sulfur compound or an inorganic sulfur compound. Any material may be used as long as it can release lithium ions during charging and occlude lithium ions during discharging by utilizing the oxidation-reduction reaction of sulfur.

The content of the positive electrode active material in the positive electrode active material layer is preferably 50 to 100 mass %, more preferably 55 to 95 mass %, and still more preferably 60 to 90 mass %.

The thickness of the positive electrode active material layer is usually 0.1 to 1000 μm and preferably 10 to 40 μm although it varies depending on the structure of the desired all-solid state battery.

Note that the following embodiments are also included in the scope of the present invention: the solid electrolyte layer according to claim 1 having the features of claim 2; the solid electrolyte layer according to claim 1 or 2, having the feature of claim 3; the solid electrolyte layer according to any one of claims 1 to 3 having the feature of claim 4; the solid electrolyte layer according to any one of claims 1 to 4 having the feature of claim 5; the solid electrolyte layer according to any one of claims 1 to 5 having the feature of claim 6; the solid electrolyte layer according to claim 6 having the feature of claim 7; the solid electrolyte layer according to claim 6 having the feature of claim 8; the production method according to claim 9, having the features of claim 10; the production method according to claim 9 or 10, having the features of claim 11; the production method according to any one of claims 9 to 11, having the features of claim 12; and the production method according to claim 12, having the features of claim 13.

### EXAMPLES

### <Preparation Example of Solid Electrolyte Layer>

### Comparative Example 1

In a glove box under an argon atmosphere at a dew point of −68° C. or lower, 3 parts by mass of an SBR-based binder was added to 100 parts by mass of Li₇P₃S₁₁ (degree of lithium-ion conductivity 1.60 mS/cm, manufactured by Ampcera Inc.) as a sulfide-based first solid electrolyte, and mesitylene was added as a solvent to prepare a first solid electrolyte slurry. Subsequently, the first solid electrolyte slurry prepared above was applied to the surface of the stainless steel foil as a support, and then dried, and the support was removed to prepare a solid electrolyte coating film as a self-supported film. Thereafter, the obtained solid electrolyte coating film was punched into $10 mm to obtain a solid electrolyte layer (thickness: 254 μm) of this Comparative Example. Note that, an image of the cross-section of the obtained solid electrolyte layer observed in the thickness direction by a scanning electron microscope (SEM) was analyzed by binarization of, i.e., solid electrolyte portion and a void-space portion. Based on the ratio of the solid electrolyte portion to the entire image, the filling rate was calculated, whereas the void ratio was calculated based on the ratio of the void-space portion. As a result, the filling rate and the void ratio were 70% and 30%, respectively.

### Comparative Example 2

The solid electrolyte coating film (punched into ¢10 mm) prepared in Comparative Example 1 was pressed at a pressing pressure of 50 MPa by a powder compacting jig having an inner diameter of $10 mm to obtain a solid electrolyte layer (thickness: 166 μm) of this Comparative Example. Note that the filling rate and void ratio of the obtained solid electrolyte layer were 73% and 27%, respectively.

### Comparative Example 3

The solid electrolyte coating film (punched into ¢10 mm) prepared in Comparative Example 1 was pressed at a pressing pressure of 100 MPa by a powder compacting jig having an inner diameter of $10 mm to obtain a solid electrolyte layer (thickness: 152 μm) of this Comparative Example. The filling rate and void ratio of the obtained solid electrolyte layer were 72% and 28%, respectively.

### Comparative Example 4

A solid electrolyte layer (thickness: 154 μm) of this Comparative Example was obtained in the same manner as in Comparative Example 3 except that a mixture of Li₇P₃S₁₁ as a first solid electrolyte and Li₆PS₅Cl (degree of lithium-ion conductivity 0.89 mS/cm, manufactured by Ampcera Inc.) as a sulfide-based second solid electrolyte (mixed mass ratio=98:2 (Li₇P₃S₁₁: Li₆PS₅Cl) was used in place of the first solid electrolyte. The filling rate and void ratio of the obtained solid electrolyte layer were 74% and 26%, respectively.

### Comparative Example 5

The solid electrolyte coating film (punched into 010 mm) prepared in Comparative Example 1 described above was pressed at a pressing pressure of 200 MPa by a powder compacting jig having an inner diameter of $10 mm to obtain a solid electrolyte layer (thickness: 144 μm) of this Comparative Example. The filling rate and void ratio of the obtained solid electrolyte layer were 78% and 22%, respectively.

### Example 1

In a glove box under an argon atmosphere with a dew point of −68° C. or lower, Li₆PS₅Cl (degree of lithium-ion conductivity 0.89 mS/cm, manufactured by Ampcera Inc.) as a sulfide-based second solid electrolyte was dissolved in super dehydrated ethanol (manufactured by FUJIFILM Wako Pure Chemical Corporation) to prepare a solution having a concentration of 20 g/L. When the degree of lithium-ion conductivity of the second solid electrolyte (Li₆PS₅Cl) dissolved in ethanol and then dried was separately measured, the conductivity was 0.05 mS/cm. Subsequently an appropriate amount of this solution was added dropwise onto the solid electrolyte coating film (punched out to φ10 mm) prepared in Comparative Example 1 described above, and dried the film at room temperature for one hour in a vacuum drying furnace to remove the solvent. This step was repeated three times. Thereafter, a heating treatment was performed at 150° C. for 6 hours in a vacuum drying furnace to prepare a self-supported film having space among particles of the first solid electrolyte impregnated with the second solid electrolyte. This film was used as a solid electrolyte layer (thickness: 225 μm) of this Example. Note that, the thickness of the solid electrolyte layer of this Example was reduced as compared with Comparative Example 1 by contact with the solution or heat treatment.

In addition, an image (observation magnification: 5000 times) of the cross-section of the obtained solid electrolyte layer observed in the thickness direction by a scanning electron microscope (SEM) was analyzed by binarization of, i.e., solid electrolyte portion and a void-space portion. Based on the ratio of the solid electrolyte portion to the entire image, the filling rate was calculated, whereas the void ratio was calculated based on the ratio of the void-space portion. Also, the same observation image was subjected to binarization of the first solid electrolyte portion and the other portion, and then, the contour points of the first solid electrolyte were extracted to calculate the length of the contour of the first solid electrolyte. In contrast, binarization of the void-space portion and the other portion was performed and the contour points of the void-space portion were extracted. In the case where the distance of the boundary portion between the contour of the first solid electrolyte and the contour of the void-space portion of 70 nm or less, the length of the contour of the first solid electrolyte was calculated. The ratio of the length of the contour of the first solid electrolyte satisfying the aforementioned distance was 70 nm or less relative to the length of the contour of the first solid electrolyte (calculated above) was calculated. The obtained value was subtracted from 1 to obtain a coverage. As a result, the filling rate and the void ratio were 90% and 10%, respectively, and the coverage was 90%. In addition, when the volume contents of the first solid electrolyte and the second solid electrolyte in the solid electrolyte layer were calculated based on the image processed by ternarization, the volume contents were 70 volt and 20 volt, respectively. In addition, the contrast of the first solid electrolyte portion was brighter than that of the second solid electrolyte portion. From this, it was found that the density of the first solid electrolyte was higher than the density of the second solid electrolyte (the same applies to the following Examples).

### Example 2

The self-supported film (punched to 010 mm) prepared in Example 1 (described above) was pressed at a pressing pressure of 50 MPa by a powder compacting jig having an inner diameter of $10 mm to obtain a solid electrolyte layer (thickness: 179 μm) of this Example. The filling rate, void ratio and coverage of the obtained solid electrolyte layer were 91%, 9% and 93%, respectively. The volume contents of the first solid electrolyte and the second solid electrolyte in the solid electrolyte layer were 73 vol % and 18 vol %, respectively.

### Example 3

The self-supported film (punched to $10 mm) prepared in Example 1 (described above) was pressed by applying a pressing pressure of 100 MPa by a powder compacting jig having an inner diameter of φ10 mm to obtain a solid electrolyte layer (thickness: 161 μm) of this Example. The filling rate, void ratio and coverage of the obtained solid electrolyte layer were 95%, 5% and 94%, respectively. The volume contents of the first solid electrolyte and the second solid electrolyte in the solid electrolyte layer were 72 vol % and 23 vol %, respectively.

### Example 4

A solid electrolyte layer (thickness: 150 μm) of this Example was obtained in the same manner as in Example 3 except that a mixture containing Li₂S and P₂S₅ in the same amounts was used in place of Li₆PS₅Cl as the second solid electrolyte, and tetrahydrofuran (THF) was used in place of super dehydrated ethanol. The degree of lithium-ion conductivity of the second solid electrolyte (Li₂S—P₂S₅) dissolved in THE was 0.01 mS/cm. The filling rate, void ratio and coverage of the obtained solid electrolyte layer were 94%, 6% and 95%, respectively. The volume contents of the first solid electrolyte and the second solid electrolyte in the solid electrolyte layer were 72 vol % and 22 vol %, respectively.

### Example 5

The self-supported film (punched to 010 mm) prepared in Example 1 (described above) was pressed by applying a pressing pressure of 200 MPa by a powder compacting jig having an inner diameter of $10 mm to obtain a solid electrolyte layer (thickness: 159 μm) of this Example. The filling rate, void ration and coverage of the obtained solid electrolyte layer were 96%, 4% and 98%, respectively. The volume contents of the first solid electrolyte and the second solid electrolyte in the solid electrolyte layer were 78 vol % and 18 vol %, respectively.

### <Preparation Example of Test Cell>

Test cells were prepared by the following method using the solid electrolyte layers produced in Comparative Examples and Examples. The following operations were performed in a glove box under an argon atmosphere at a dew point of −68° C. or lower.

First, 40 g of zirconia balls of 5 mm in diameter, 0.100 g of sulfur, 0.080 g of Li₇P₃S₁₁ as a solid electrolyte, and 0.020 g of carbon as a conductive aid were placed in a zirconia container of 45 mL in volume, and treated by a planetary ball mill at 370 rpm for 6 hours to obtain a powder of a sulfur positive electrode mixture.

Subsequently, a stainless steel cylindrical convex punch (10 mm diameter, also serving as negative electrode current collector) was inserted into a portion on one of the sides of a cylindrical tube jig (tube inner diameter: 10 mm, outer diameter: 23 mm, height: 20 mm) made of MACOR, and the solid electrolyte membrane and the sulfur positive electrode mixture prepared above were introduced in this order from the upper portion of the cylindrical tube jig. Thereafter, another stainless steel cylindrical convex punch was inserted so as to sandwich the stack, and pressed by applying a pressure of 300 MPa for 3 minutes by a hydraulic press. Subsequently, the cylindrical convex punch on the lower side was removed. Subsequently, a lithium foil (manufactured by The Nilaco Corporation, thickness: 0.20 mm) punched into a circle of 8 mm in diameter and an indium foil (manufactured by The Nilaco Corporation thickness: 0.30 mm) punched into a circle of 9 mm in diameter were stacked as a negative electrode, and the negative electrode was inserted from the lower portion of the cylindrical tube jig so that the indium foil was positioned closer to the solid electrolyte layer. Thereafter, a cylindrical convex punch (negative electrode current collector) was inserted again and pressed by applying a pressure of 75 MPa for 3 minutes. As described above, a test cell (all-solid-state lithium secondary battery) having a laminate formed by stacking a negative electrode current collector (punch), a lithium-indium negative electrode, a solid electrolyte layer, a positive electrode active material layer, and a positive electrode current collector (punch) in this order, was prepared.

### <Evaluation Example of Test Cell>

In a thermostatic bath set at a constant temperature of 25° C., the evaluation for the charge-discharge characteristics of the test cell (all-solid-state lithium secondary battery) prepared above was performed by the following method using a charge-discharge test apparatus (HJ-SD8 manufactured by HOKUTO DENKO CORPORATION).

First, a test cell was placed in a thermostatic bath. After the cell temperature became constant, conditioning the cell was performed as follows: constant current discharge was performed at a current density of 0.2 mA/cm² up to a cell voltage of 0.5 V. Subsequently constant-current constant-voltage charge was performed at the same current density with a cut-off current set to 0.01 mA/cm², up to 2.5 V. After repeating this charge/discharge cycle for conditioning 3 times, a CC charge/discharge cycle test was performed at a current density of 0.02 mA/cm² in a voltage range of 0.5 to 2.5 V, 30 cycles. Here, 10 test cells per time were subjected to the same charge and discharge cycle test. The percentage of the number of test cells that could perform the charge and discharge cycles up to 30 cycles was calculated as the survival rate [%]. The results are shown in Table 1 below. Note that, when the test cell which could not be charged and discharged in the middle of 30 cycles was disassembled and the inside thereof was observed, it was confirmed that a dendrite generated from the lithium metal of the negative electrode passed through the solid electrolyte layer, thereby causing an internal short-circuit.

TABLE 1

| | First | | Second | | | Pressing | Filling | | Volume | | Thickness of | 30-cycle |
|---|---|---|---|---|---|---|---|---|---|---|---|---|
| | solid | | solid | | Concentration | pressure | rate | Coverage | content [%] | | electrolyte | survival |
| | electrolyte | Binder | electrolyte | Solvent | [g/L] | [MPa] | [%] | [%] | First | Second | layer [μm] | rate [%] |
| Comparative | Li₇P₃S₁₁ | SBR base | — | — | — | — | 70 | — | 70 | — | 254 | 0 |
| Example 1 | | | | | | | | | | | | |
| Comparative | Li₇P₃S₁₁ | SBR base | — | — | — | 50 | 73 | — | 73 | — | 166 | 0 |
| Example 2 | | | | | | | | | | | | |
| Comparative | Li₇P₃S₁₁ | SBR base | — | — | — | 100 | 73 | — | 72 | — | 152 | 0 |
| Example 3 | | | | | | | | | | | | |
| Comparative | Li₇P₃S₁₁ | SBR base | — | — | — | 100 | 74 | — | 74 | — | 154 | 0 |
| Example 4 | Li₆PS₅Cl | | | | | | | | | | | |
| Comparative | Li₇P₃S₁₁ | SBR base | — | — | — | 200 | 78 | — | 78 | — | 144 | 0 |
| Example 5 | | | | | | | | | | | | |
| Example 1 | Li₇P₃S₁₁ | SBR base | Li₆PS₅Cl | Ethanol | 20 | — | 90 | 90 | 70 | 20 | 225 | 40 |
| Example 2 | Li₇P₃S₁₁ | SBR base | Li₆PS₅Cl | Ethanol | 20 | 50 | 91 | 93 | 73 | 18 | 179 | 50 |
| Example 3 | Li₇P₃S₁₁ | SBR base | Li₆PS₅Cl | Ethanol | 20 | 100 | 95 | 94 | 72 | 23 | 161 | 60 |
| Example 4 | Li₇P₃S₁₁ | SBR base | Li₂S:P₂S₅ | THF | 20 | 100 | 94 | 95 | 72 | 22 | 150 | 60 |
| | | | (50:50) | | | | | | | | | |
| Example 5 | Li₇P₃S₁₁ | SBR base | Li₆PS₅Cl | Ethanol | 20 | 200 | 96 | 98 | 78 | 18 | 159 | 70 |

From the results shown in Table 1, it is found that according to the present invention, in a lithium secondary battery having a solid electrolyte layer, occurrence of an internal short-circuit due to a dendrite composed of lithium metal can be effectively suppressed.

Furthermore, it is also found that the cycle durability of the test cell (all-solid-state lithium secondary battery) is improved by performing the press step at the time of preparing the solid electrolyte layer and applying a larger pressing pressure at this time. This is considered because the solid electrolyte layer became denser as the pressing pressure increases and internal short-circuit caused by a dendrite passing through the solid electrolyte layer was more effectively suppressed.

The present application is based on Japanese Patent Application No. 2022-126867 filed on Aug. 9, 2022, the disclosure content of which is incorporated herein by reference in its entirety.

### REFERENCE SIGNS LIST

10a Laminate type secondary battery
11′ Negative electrode current collector
11″ Positive electrode current collector
13 Negative electrode active material layer
14 Negative electrode intermediate layer
15 Positive electrode active material layer
17 Solid electrolyte layer
17a First phase (Li₇P₃S₁₁) of solid electrolyte layer
17b Second phase (Li₆PS₅Cl) of solid electrolyte layer
19 Single battery layer
21 Power generating element
25 Negative electrode current collecting plate
27 Positive electrode current collecting plate
29 Laminate film

1. A solid electrolyte layer for a lithium secondary battery, comprising:
a plurality of particles of a first solid electrolyte; and
a second solid electrolyte coating a surface of the plurality of particles and filling in a space among the plurality of particles, wherein
the second solid electrolyte is a sulfide solid electrolyte or an oxide solid electrolyte.

2. The solid electrolyte layer for the lithium secondary battery according to claim 1, wherein both the first solid electrolyte and the second solid electrolyte are the sulfide solid electrolytes.

3. The solid electrolyte layer for the lithium secondary battery according to claim 1, wherein a filling rate is 90% or more.

4. The solid electrolyte layer for the lithium secondary battery according to claim 1, wherein a coverage of the plurality of particles with the second solid electrolyte is 90% or more.

5. The solid electrolyte layer for the lithium secondary battery according to claim 1, wherein a density of the first solid electrolyte is higher than a density of the second solid electrolyte.

6. The solid electrolyte layer for the lithium secondary battery according to claim 1, wherein a content of the first solid electrolyte is 50 vol % or more.

7. The solid electrolyte layer for the lithium secondary battery according to claim 1, wherein a content of the first solid electrolyte is 70 vol % or more.

8. The solid electrolyte layer for the lithium secondary battery according to claim 6, wherein a degree of lithium-ion conductivity of the first solid electrolyte is higher than a degree of lithium-ion conductivity of the second solid electrolyte.

9. A method for producing a solid electrolyte layer for a lithium secondary battery, comprising:
adding a solution having a second solid electrolyte dissolved in a solvent to a layer of particles of a first solid electrolyte, thereby impregnating a void space between the particles of the first solid electrolyte with the second solid electrolyte and forming a solid electrolyte layer precursor; and
removing at least some of the solvent, thereby forming the solid electrolyte layer, wherein
a solubility of the second solid electrolyte in the solvent is higher than a solubility of the first solid electrolyte in the solvent.

10. The method for producing the solid electrolyte layer for the lithium secondary battery according to claim 9, further comprising, after removing at least some of the solvent, heating the solid electrolyte layer.

11. The method for producing the solid electrolyte layer for the lithium secondary battery according to claim 9, further comprising, after removing at least some of the solvent, applying a pressure to the solid electrolyte layer.

12. The method for producing the solid electrolyte layer for the lithium secondary battery according to claim 9, further comprising, after adding the solution and before removing at least some of the solvent, placing the solid electrolyte layer precursor under a reduced pressure condition, thereby permeating the solution into the solid electrolyte layer precursor.

13. The method for producing the solid electrolyte layer for the lithium secondary battery according to claim 12, wherein the adding the solution, the placing the solid electrolyte layer precursor under the reduced pressure condition and the removing at least some of the solvent are repeated twice or more.

14. The solid electrolyte layer for the lithium secondary battery according to claim 2, wherein a filling rate is 90% or more.

15. The solid electrolyte layer for the lithium secondary battery according to claim 2, wherein a coverage of the plurality of particles of the first solid electrolyte with the second solid electrolyte is 90% or more.

16. The solid electrolyte layer for the lithium secondary battery according to claim 2, wherein a density of the first solid electrolyte is higher than a density of the second solid electrolyte.

17. The solid electrolyte layer for the lithium secondary battery according to claim 2, wherein a content of the first solid electrolyte is 50 vol % or more.

18. The solid electrolyte layer for the lithium secondary battery according to claim 2, wherein a content of the first solid electrolyte is 70 vol % or more.

19. The method for producing the solid electrolyte layer for the lithium secondary battery according to claim 10, further comprising, after heating the solid electrolyte layer, applying a pressure to the solid electrolyte layer.

20. The method for producing the solid electrolyte layer for the lithium secondary battery according to claim 10, further comprising, after adding the solution and before removing at least some of the solvent, placing the solid electrolyte layer precursor under a reduced pressure condition, thereby permeating the solution into the solid electrolyte layer precursor.
